(19) United States
(12) Patent Application Publication
(10) Pub. No.: US 2004/0198380 A1
(43) Pub. Date: Oct. 7, 2004

(54) Providing rebates of mobile telecommunication call charges at selected geographical locations

(76) Inventor: Musa Raoul Unmehopa, Amersfoort (NL)

Correspondence Address: Docket Administrator (Room 3J-219), Lucent Technologies Inc., 101 Crawfords Corner Road, Holmdel, NJ, 07733-3030, US

(21) Appl. No.: 10/246,913

(22) Filed: Sep. 19, 2002

(51) Int. Cl. H04Q 7/20

(52) U.S. Cl. 455/456.1; 455/406

(57) ABSTRACT

In a mobile telecommunication system information is recorded that indicates whether or not a mobile station is present at a predetermined geographical location. The telecommunication system transmits a charge modification signal if the mobile station to initiates a call when the location information indicates that the mobile station is present at the geographical location. The modification effects a differentiation between the overall charge for the call and a net charge to a subscriber of the mobile station, at the expense of a third party when the mobile station is present at the geographical location. Thus, a party, such as a supermarket, that does business on commercial premises is enabled to provide an incentive for consumers to enter the premises.

### BACKGROUND OF THE INVENTION

1. Field of the Invention

The invention relates to a telecommunication system and a method of operating such a system.

2. Description of the Related Art

Mobile telecommunication makes use of a system of mobile stations, base stations that exchange wireless messages with the mobile stations in an area serviced by the base station and a switching network for routing messages for the mobile station to and from a base station that service the area where the mobile station is present.

Known mobile telecommunication systems support various forms of charging costs for calls made by the mobile stations. In the most frequently used way of charging charges for all calls made by a mobile station, the telecommunication system are entered into an electronic account for that mobile station. The charge for a call generally depends on the region or broad area from which the call is made and the number to which the call is made. Entry of the charge may involve computing a subtraction from an amount of prepaid credit or addition to an amount of debit that will be used to generate a bill.

Alternative forms of charging supported by telecommunications include charging for collect calls in which the telecommunications system the charge is entered into the electronic account of a called number, after the telecommunications system has received confirmation that the call has been accepted by the called number.

Thus, known telecommunications systems support various forms of charging calls to customers that are directly involved with the calls.

### SUMMARY OF THE INVENTION

An embodiment of the present invention provides a telecommunication system and a method of operating such a system that allows a third party that may be associated with a geographical location to sponsor charges for calls made from the geographical location.

A charge for a call levied from the subscriber of a mobile telephone is reduced when the mobile telephone is operated from a predetermined geographical location or area. The charge is reduced at the expense of a third party, that is, by involving a third party in addition to the operator of the telecommunication system and a subscriber of the mobile station. (Herein “subscriber” refers any type of subscriber, including pre-paid subscribers and subscribers that are billed later).

The reduction is realized for example by recording a part of the overall charge for the call in an account for the subscriber of the mobile telephone and another part in an account of the third party, or by sending information about the call to a terminal of the third party, as assigned in the telecommunication system, to enable the third party to pay a refund at the predetermined geographical location itself.

The present invention enables the third party to sponsor calls made by mobile stations of the telecommunication system from a predetermined geographical location or area. Thus a third party, a shop owner for example, is enabled to use a reduction of calling costs as an incentive for entering his or her location.

In another embodiment, the presence of the mobile station at the predetermined geographical location may be detected automatically before the call is made, calls subsequent to detection being subject to the change of charging. As an alternative, the entry and departure of the mobile station may be recorded manually at a third party terminal. In case of automatic detection of entry and/or departure preferably a welcome and/or farewell message is sent to the mobile station to give notice of the entitlement to a change in call charges or the termination thereof. The detection mechanism for detecting presence at the predetermined location may be provided in addition to the normal location update mechanism of the mobile telecommunication system and thereby improve the ability to accurately determine the mobile station's location.

The presence of the mobile station at the predetermined geographical location may be detected automatically from signals received during a call. For example, presence in a geographical area may be determined by testing for knowledge of a password supplied dependent on presence in the geographical location, or by measuring properties of the signals from the mobile station.

### BRIEF DESCRIPTION OF THE DRAWINGS

These and other advantageous aspects of the system and method according to the invention will be described in more detail using the following figures.

FIG. 1 shows a telecommunication system

FIG. 2 illustrates a protocol for handling a call; and

FIG. 3 shows part of a telecommunication system.

### DETAILED DESCRIPTION OF THE INVENTION

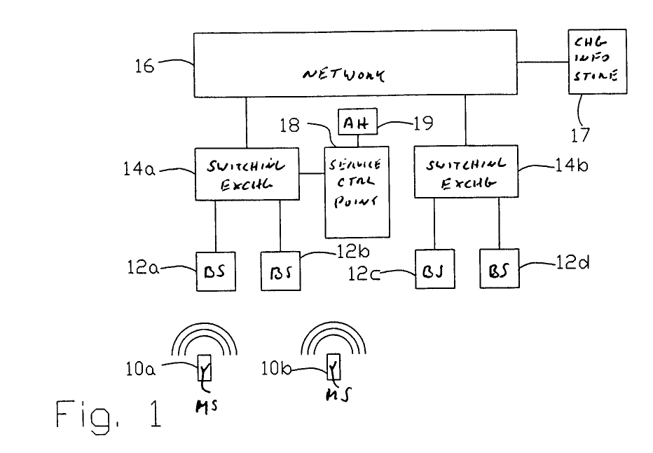

FIG. 1 shows a telecommunication system. The system contains mobile stations 10a,b, base stations 12a-d, switching exchanges 14a-b, a network 16, charge information storage 17 and a service control point 18. Each base station 12a-d serves a different geographical cell (not shown) in which mobile stations 10a,b may be located. The mobile stations 10a,b have a wireless coupling to the base stations 12a-d, which are coupled to the network 16 via switching exchanges 14a-b. Switching exchanges 14a-b are coupled to service control point 18, which is coupled to an application handler 19. The charge information storage 17 is coupled to the network 16.

In operation, the system allows mobile stations 10a,b to place calls via network 16. When a mobile station 10a,b originates a call, it transmits an originating signal, which is received by a base station 12a-d of the cell in which the mobile station 10a,b is located. The base station 12a-d forwards the originating signal to the switching exchange 14a-b to which it is connected. In response the switching exchange 14a-d sets up the call. For this purpose switching exchange 14a-b exchanges information with service control point 18, which supplies information about the way in which the call should be charged. When the call has been completed charge information is sent to charge information storage 17 and stored therein, in an account assigned to the mobile station 10a-b for later billing or by deduction from a pre-paid balance.

The system allows selection between different ways of charging, dependent on detection whether the mobile station is present at a predetermined geographical location. The geographical location may be for example commercially exploited premises, such as a shop or trade show ground, whose owner wants to induce customers to enter the premises by offering a discount on calls originated from the premises. Of course, the telecommunication system may allow for giving discounts for a plurality of such predetermined geographical locations, but for the purpose of illustration giving reductions for only one such location will be described.

Upon entry of a mobile station 10a-b into the predetermined geographical location, information is entered in application handler 19 to indicate that mobile station 10a-b qualifies for the discount. Upon departure from the predetermined geographical location this information is updated to indicate that the mobile station 10a-b no longer qualifies for the discount.

When a call originates from mobile station 10a-b switching exchange 14a-b consults service control point 18 to determine charging plan. If no information is present to indicate that the mobile station 10a-b is at the predetermined geographical location, service control point 18 responds by signalling to the switching exchange 14a-b that the call should be charged in a way that is normal for the mobile station 10a-b. If information is present that indicates that the mobile station 10a-b is at the predetermined geographical location, service control point 18 responds by signalling to the switching exchange 14a-d, service control point 18 triggers switching exchange 14a-d to report establishment and termination of the connection for the originating call through network 16 and to report the time duration of the call. Switching exchange 14a-b sends these reports accordingly. The reports are passed to an application in application handler 19 which handles charging of the call, causing a discount to be given to the caller.

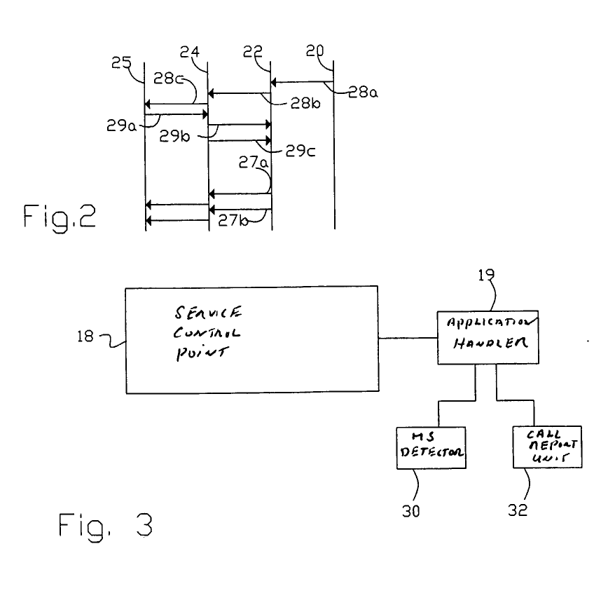

FIG. 2 illustrates messages involved in an embodiment of a protocol for handling calls that qualify for a rebate. The figure symbolizes uses vertical lines 20, 22, 24, 26 to symbolize the mobile station 10a-b, the switching exchange 14a-b, the service control point 18 and the application in application handler 19 respectively. Signals passed are indicated as arrows each from a vertical line 20, 22, 24, 26 symbolizing a source to a vertical line 20, 22, 24, 26 symbolizing a destination. Progressive time is indicated from top to bottom.

A first signal 28a (vertically highest arrow) is sent by a mobile station 10a-b to originate a call. In response switching exchange 14a-b sends a second signal 28b to service control point 18, which in turn sends a signal 28c to the application. In response the application verifies whether the mobile station is located in the predetermined geographical location, first of all by verifying whether information has been recorded about the entry of the mobile station into the location and secondly (optionally) by confirming whether the call qualifies for a reduction, for example by detecting whether the mobile station is still in the geographic location. This may involve a further exchange of signals (not shown).

Subsequently, if the mobile station 10a-b is present at the location, the application sends signals 29a,b to the service control point 18 calling for charging information to be sent to the application and to route the call. Service control point 18 forwards these signals to the switching exchange 14a-d that is handling the call and itself sends a signal 29c that causes the switching exchange 14a-d to connect the call. Thereupon, switching exchange 14a-b establishes the call and notifies establishment to the application via the service control point 18.

When the call is disconnected switching exchange 14a-b send signals 27a,b reporting disconnection to service control point 18 which forwards these signals to the application. In response the application charges the call and provides for the discount.

FIG. 3 shows part of the system connected to the service control point 18 in an embodiment of the system according to the invention. In this embodiment a mobile station detector 30 is coupled to the application handler 19. In addition an optional call reporting unit 32 is coupled to the application handler 19.

In operation mobile station detector 30 detect entry and departure of mobile stations 10a-b into and from the predetermined geographical location and sends signals to report this to application handler 19, in order to enter the information about the presence of the mobile station 10a-b at the geographical location. Preferably, the report signal is sent via a conventional telephone line and conventional message passing through the telecommunication system, but as an alternative a direct connection to the application handler 19 may be used.

Any technique may be used to detect the presence of mobile stations 10a-b in the geographical area. Mobile station detector 30 may be realized simply as an input terminal into which an operator at the geographical location enters the telephone number of the mobile station upon request when a possessor of the mobile station 10a-b enters into the geographical location or departs from it. As an alternative detector 30 may use automatic detection, using for example a receiver that receives conventional operating signals from the mobile stations 10a-b in the geographical location, detects their presence if their signal strength exceeds a predetermined threshold and sends a signal identifying the mobile station 10a-b to application handler 19. As another alternative detector 30 may contain one or more entrance gates to the geographical area that detect the passage of the mobile station 10a-b and send signals reporting the passage to application handler 19. In yet another alternative detector 30 may contain two or more receivers that obtain cross-bearing of signals from mobile stations 10a-b to detect their presence in the geographical area, for reporting to application handler 19. Of course, when the geographical location coincides with a cell of the mobile telecommunication system, detection of presence of the mobile station could also be performed using the conventional detection mechanism for detecting roaming mobile stations, but usually the geographical location will be smaller than a single cell, or it might straddle parts of different cells, and therefore a separate location detection mechanism specifically directed at the predetermined geographical location is preferred.

Without deviating from the invention various refinements may be applied to the system. For example, in one embodiment, a welcome/farewell message, using for example an SMS message (SMS=Short Message Service) or a voice message, may be sent to the mobile station 10a-d when it qualifies and/or stops qualifying for the discount, i.e. when the system has detected that the mobile station 10a-b has entered or left the predetermined geographical area. Obviously, advertising information may be added to these messages. In addition, the possessor of the mobile station may be required to reply to the welcome message by sending a confirmation message to accept qualification for the discount. The confirmation may be subject to a requirement that the confirmation message contains certain specified information, for example a password supplied to the possessor of the mobile station 10a-b in order to restrict the use of discounts, or for example information derived from the welcome message in order to induce the possessor to take note of the welcome message etc.

Various alternative ways of giving a discount can be realized. In one embodiment the application in application handler 19 causes a first fraction of for example 90% of a normal call charge top be added to information about the account maintained for the mobile station 10a-b in the telecommunication system, i.e. by adding the charge for later billing, or by subtraction from a pre-paid account; a remainder of for example 10% is charged to a discounter account specified for the predetermined geographical location. This discounter account will then later be settled by the person that provides the discount. Obviously, instead of a fraction any fixed amount may be deducted, or any other call dependent amount. As an alternative the discount need not be charged to the discounter account at all if the operator of the telecommunication system sponsors the discount.

In another embodiment, the application provides for normal charging of the call, but sends an additional signal to an optional terminal 32 specified for the predetermined geographical location in the application run by application handler 19. This signal enables an operator at the terminal to reimburse part of the call costs, for example as an express reimbursement the possessor of the mobile station 10a-b leaves the predetermined geographical location, or as a rebate to the bill for products or services bought by the possessor of the mobile station 10a-b. In the latter case, the terminal 32 is preferably coupled to bill printing equipment (not shown).

In another refinement, each originating call may be subject to further confirmation before the discount is effected. This may be realized for example by requiring the caller to enter a password for each call when origination the call prior to granting the discount. In this case, service control point 18 initially causes switching exchange 14a-b to route the originating call to a password verification device (not shown) which receives password information from the mobile station 10a-b. This may be realized for example using speech recognition of sound signals received from mobile station 10a-b, or by verification of keys activated on mobile station 10a-b. Password verification device sends a signal reporting the result of verification to application handler 19. In response, if the password has been correctly entered, the application in application handler 19 causes switching exchange 14a-b to route the call to a destination selected from mobile station 10a-b. The password may be time-variable, as supplied by one or more display devices at the geographical location which are visible from everywhere at the location or supplied by a “token” device given to the possessor of the mobile station 10a-b when he or she enters the predetermined location.

As an alternative a hardware solution may be used to confirm the that the mobile station 10a-b is at the predetermined location when the call is originated. This may be realized for example by measuring signal strength of the mobile station at the predetermined location or by taking a cross bearing of the signal from the mobile station 10a-b, or some form of imperceptible sound signal similar to a watermark (known per se) may be generated in the predetermined location and detected from the background sound picked up by mobile station 10a,b and transmitted to switching exchange 14a-b.

Although the invention has been described in terms of a particular example, it will be appreciated that the invention is not limited to these examples. For example, without deviating from the invention the various functions involved, such as keeping information about entitlement to the rebate, approval of the call and the rebate, effectuation of the rebate, detection of presence in the geographical location etc. may be performed or communicated from other locations in the telecommunication system than those shown in the example.

Furthermore, although the invention has been described with respect to reductions of call costs, it will be appreciated that, without deviating from the invention it may be applied to increases of call costs, for example to discourage mobile calls from certain locations such as distinguished restaurants, or to recover profit from a location where valuable information, such as about current stock values, is available. In this case, obviously, the service is preferably applied automatically (without requesting a password) and is preferably notified by means of a message, at least on entry to the location but preferably also each time a call is placed before any charge is added.

1. A method of operating a telecommunication system, comprising the steps of:
determining a location of a mobile station; and
reducing a charge to a subscriber account associated with the mobile station at the expense of a party associated with the location.

2. The method of claim 1, further comprising the step of charging an account associated with the party when the mobile station is used.

3. The method of claim 2, further comprising the step of informing the third party of the mobile station's use.

4. The method of claim 1, further comprising the step of informing the third party of the mobile station's use.

5. The method of claim 4, wherein the step of informing includes a request to provide a credit associated with the mobile station's use.

6. A method of operating a mobile telecommunication system, the method comprising the steps of:
recording location information in the telecommunication system indicating whether or not a mobile station is present at a predetermined geographical location;
detecting a signal from the mobile station to initiate a call;
storing charging information crediting an overall charge for the call to an operator of the telecommunication system; and, upon detection of the signal to initiate the call when the location information indicates that the mobile station is present at the geographical location;
setting up the telecommunication system to transmit a charge modification signal; and
effecting a differentiation between the overall charge and a net charge to a subscriber of the mobile station, at the expense of a third party in response to the charge modification signal.

7. The method of claim 6, wherein said storing comprises storing a charge for a part of a charge for the call into an account for the mobile station and a charge for a further part of the charge for the call into an account assigned to the predetermined geographical location in response to the charge modification signal.

8. The method of claim 6, wherein the charge modification signal is transmitted to a third party terminal, said effecting comprising refund of at least a part of the charge by the third party under control of the third party terminal.

9. The method of claim 6, wherein said recording comprises further detecting a signal from the mobile station and testing this signal to determine a test result indicative of entry and/or departure of the mobile station into and/or from the predetermined geographical location, the information being recorded in response to the test result.

10. The method of claim 9, comprising sending a welcome and/or farewell message to the mobile station in response to said test result, upon detection of entry into and/or departure from the predetermined geographical location respectively.

11. The method of claim 6, wherein the setting up comprises testing whether the signal from the mobile station contains information indicative of continued presence of the mobile station at the predetermined geographical location, said transmitting of the charge modification signal being performed conditional on a positive result of said testing.

12. A telecommunication system comprising:
a detection device for detecting whether or not a mobile station is present at a predetermined geographical location;
an application handling device coupled to the detection device; and
a call handling unit, the call handling unit being arranged to send a message to the application handling device upon origination of a call from a mobile station, the application handling device being arranged to report, in response to said message, information that enables a charge for the call to be changed by a third party, not being an operator of the telecommunication system or a subscriber of the mobile station, when the detection device has detected that the mobile station is present at the geographical location.
